(19) United States
(12) Patent Application Publication
(10) Pub. No.: US 2015/0324466 A1
(43) Pub. Date: Nov. 12, 2015

(54) Adaptable Home Automation Network and Methods

(71) Applicant: Hai Dau, San Ramon, CA (US)

(72) Inventor: Hai Dau, San Ramon, CA (US)

(21) Appl. No.: 14/270,476

(22) Filed: May 6, 2014

(51) Int. Cl. G06F 17/30; H04L 29/08

(52) U.S. Cl. CPC G06F 17/30867; G06F 17/3053; H04L 67/10; H04L 67/16; H04L 67/12

(57) ABSTRACT

In one embodiment, the present invention includes a method of providing content to a user. The method comprises initiating a focused search for the content on the internet in response to satisfaction of a criterion rather than any deliberate action of said user. The focused search corresponds to an interest of the user.

### CROSS REFERENCE TO RELATED APPLICATIONS

Not applicable.

### BACKGROUND

The present invention relates to home networks, and in particular, to adaptable home automation networks and methods.

The inexpensive computer chip has brought about the automation of many tasks within our homes. We have dishwashers, washers, blenders and all sorts of household devices which can be programmed into a wide variety of modes. The versatility of our electronic devices allows for a great deal of alternatives, but this increase in functionality is lost in a multitude of complexity.

The internet has brought a wealth of knowledge into our homes. However, the increase of knowledge is lost in a mountain of useless and/or unwanted information. Some devices have computer chips that can be remotely accessed from the internet using a smartphone or laptop, but the problem of complexity and usefulness has yet to be solved. Therefore, there is a need for adaptable home automation networks and methods.

### SUMMARY

Embodiments of the present.

Embodiments of the present invention include a.

The following detailed description and accompanying drawings provide a better understanding of the nature and advantages of the present invention.

### BRIEF DESCRIPTION OF THE DRAWINGS

FIG. 1 illustrates adaptable home automation network according to one embodiment of the invention.

FIG. 2 illustrates a method of providing content to a user according to one embodiment of the invention.

FIG. 3 illustrates a method of providing service to a user according to another embodiment of the invention.

FIG. 4 illustrates a method of providing a home network according to another embodiment of the invention.

### DETAILED DESCRIPTION

Described herein are techniques for adaptable home automation networks and methods. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

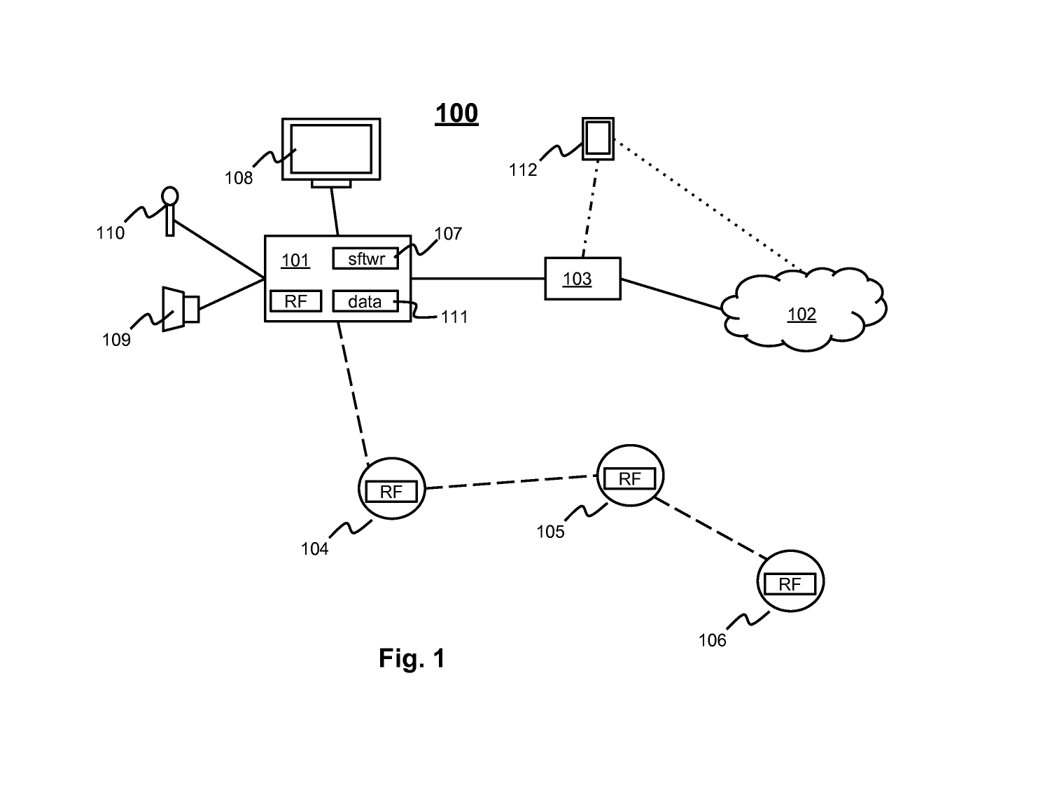

FIG. 1 illustrates adaptable home automation network 100 according to one embodiment of the invention. Computer 101 is coupled to the internet 102. The coupling may be accomplished through wireless communication such as Wi-Fi or through wired communication such as Ethernet, for example. Computer 101 may be coupled through modem/router 103 to internet 102. Computer 101 is coupled to display 108, speaker 109, and microphone 110. Computer 101 may be RF enabled and coupled to radio frequency (RF) enabled devices 104-106 forming a wireless mesh network that allows computer 101 with software 107 to adapt its methods and configuration to assist family members of the home with relevant useful options in a straight forward manner.

Computer 101 may display initial visual options via display 108 and provide audio prompts via speaker 109 for a user. A user may be prompted for personal information which may be stored on computer 101. The data may be entered through microphone 110 and computer 101 may be equipped with voice recognition software. In an alternate embodiment, internet voice recognition software is utilized.

The personal information may be used to set up a user profile of a user in database 111. The voice recognition software may be able to identify a user in the future and use the user profile to tailor access and/or preferences for a user. Each user may have a personal profile which may be updated periodically with user history information to help control and improve the user experience.

In one embodiment, a user may have an interest. This may be an interest in a favorite football team, for example. A user may have indicated their favorite football team to computer 101 during an initial discourse with computer 101 or history information stored in database 111 may be used to determine a user's interest in this favorite football team. User interests may be used by software 107 to transform software initiated searches to internet 102.

In one embodiment, RF enabled device 106 may be a baby monitor. Device 106 may have an infrared camera designed to detect the temperature of the baby. In this embodiment, device 106 may send information to computer 101 via the mesh network in order to monitor the baby under particular criterion. If the baby's temperature rises above a particular level computer 101 may send an alarm to the room via a smart phone or other RF enabled device (not shown).

In another embodiment, RF enabled device 105 is a garage door device. In this embodiment, RF enabled device 106 may be a motion sensor which senses that nobody is home. Maybe everyone in family has left the house without shutting the garage. Computer 101 using software 107 may use a schedule to poll RF enabled device 105-106 for a status. If it is determined that nobody is at home and the garage is open, computer 101, using software 107, may send a command to RF enabled device 105 to shut the garage door.

In another embodiment, RF enable devices 104-105 may be lighting elements which may be turned off under a criterion. For example, computer 101, using software 107, may send commands to RF enabled devices 104-105 to turn off the lights under the criterion that the time is past 9 am during a weekday and vacancy was detected by RF enable device 106 (i.e. motion detector). In another embodiment, a history of vacancy during this time and day may be used as additional criterion to turn off the lights.

In yet another embodiment, computer 101 provides phone service through the internet as well as streaming video. Display 108 may be showing a video and a call me be detected by computer 101. In this embodiment, a blinking phone icon may appear in the bottom banner of display 108 indicating the incoming call. A user may wish to take the call and speak the words “take the call” which is picked up by microphone 110 and computer 101 mutes the streaming audio and says “incoming call”. Now a user may take the call using computer 101, speaker 109, and microphone 110. In another embodiment, the video may be paused. In yet another embodiment, the phone icon may show caller identification such as an avatar or picture on file or online with Facebook or Linked-In.

In another embodiment computer 101 may communicate to a user by texting to smartphone 112. Smartphone 112 may have additional software to communicate with computer 101 via a home Wi-Fi network or cellular network. In this embodiment, a user may speak to smart phone 115 a particular request which will be received by computer 101 and executed on any number of RF enabled devices (e.g. RF enabled devices 104-106). For example, a user may say “close blinds” and this request may be sent via the home Wi-Fi network to computer 101 which determines a user is in the master bedroom and issues a command to RF enabled device 106 through the mesh network to close the blinds.

In another embodiment, a user may be outside gardening when the pizza in an RF enabled oven (not shown) is ready. This information may be sent to a user's smart phone as an alarm with a notice stating “OVEN TIMER”. The alarm sounded may be made to sound identical to the alarm sounded by the actual RF enabled oven.

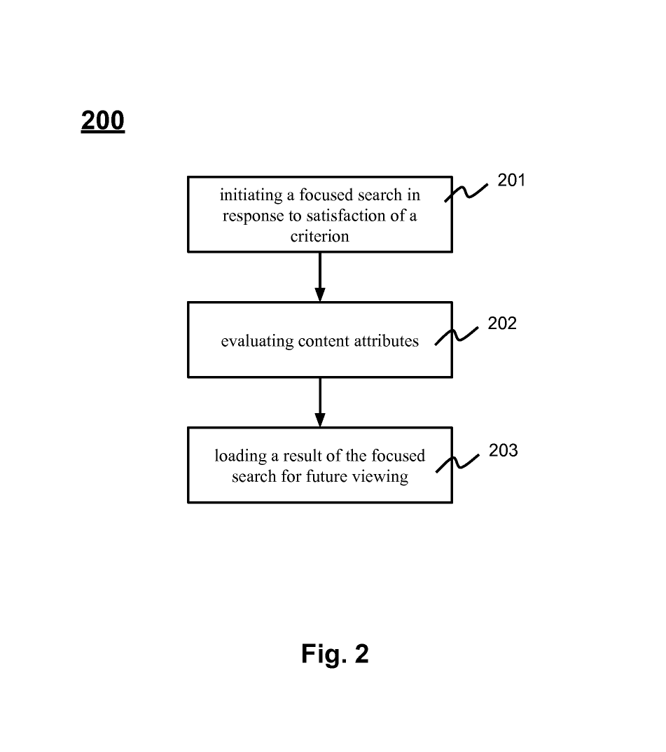

FIG. 2 illustrates a method 200 of providing content to a user according to one embodiment of the invention. The method 200 includes initiating a focused search, loading a result for future viewing, and evaluating content attributes.

At 201, initiate a focused search for content on the internet. This focused search is initiated in response to a criterion rather than any deliberate action of the user. The focused search corresponds to an interest of the user. For example, a user may have indicated that she is interested in a particular television show. During the night, while she is sleeping, focused search may be initiated for content relevant to the particular television show. In one embodiment, the time and the date may be part of the criterion to initiate the focused search. In this case, the user would not have to deliberate over the scheduling of the new season or initiate the search by interfacing with an electronic device.

At 202, load a result of the focused search for future viewing by the user. In one embodiment, a focused search may have been initiated days before to determine the availability of a new season of a show. The results of that search may have queued up an additional operation to download the first episode of the show at night on the date available. Each episode may be scheduled for download on successive weekdays accordingly when viewing time is limited to 2 hours by the user's personal profile.

At 203, evaluate content attributes according to a second criterion, the content attributes corresponding to a result of the focused search. The second criterion includes consideration of a future viewing experience of the user in regard to the result. In one embodiment, there are many websites which have content regarding the Washington Redskins football team. The computer software (e.g. software 107 of FIG. 1) may evaluate each website to see if the streaming of the video is of a quality resolution corresponding to the video screen. The software may also evaluate if the website is active or whether popups persist on the website. The software may exclude the websites which detract from the viewing experience. In some embodiments the quality of the audio may also be considered as part of the viewing experience.

In one embodiment, the content attributes includes a download speed from each website corresponding to the result. In another embodiment, the content attributes includes updates to the content and the second criterion includes a schedule of content retrieval from a predetermined set of content providers. The predetermined set of content providers may be established from a history of user experiences having the interest in common. In another embodiment, the content attributes include an element of a set and the evaluating includes prioritizing the content which is more exclusive to the element. The element may correspond to the interest such as a sports team, for example.

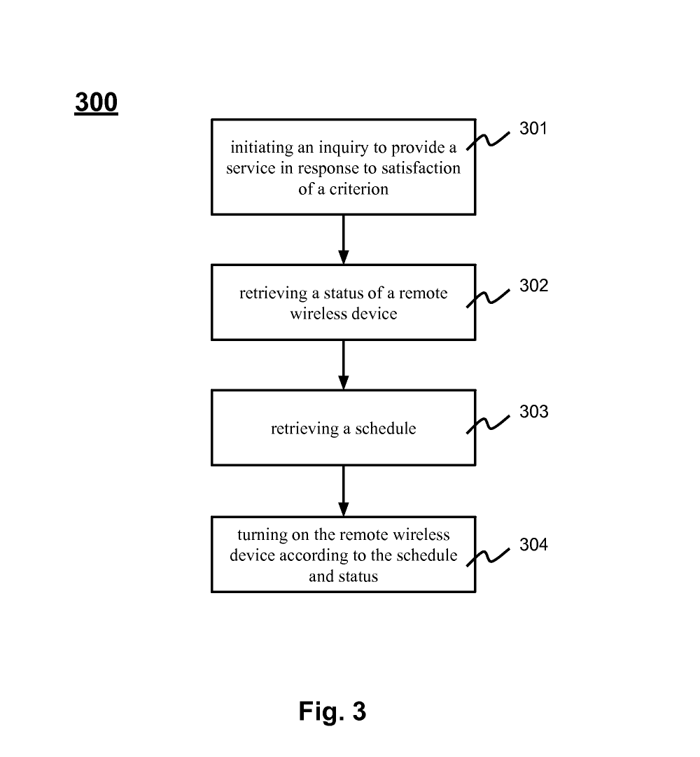

FIG. 3 illustrates a method 300 of providing service to a user according to another embodiment of the invention. The method includes initiating an inquiry, retrieving a status, and turning on a function.

At 301, initiate an inquiry to provide the service in response to a criterion rather than any deliberate action of the user. The inquiry may be an audio prompt or request for confirmation of an anticipated need. For example, a user may return to the kitchen several times and open the refrigerator. After the third time, the refrigerator, equipped with a microphone and speaker and coupled into a mesh network, may inquire “Do you want to add something to the grocery list?” The criterion may be the frequency of opening the refrigerator and/or may be the duration in which the refrigerator door remains open. If the user says “yes, add some milk and pickles”, the refrigerator may receive this message and communicate with an appropriate node on the network to translate the message and add the items to a grocery list ultimately accessible from anywhere via the internet and a smartphone.

At 302, retrieve a status of a RF enable device. The status corresponds to the criterion. The criterion may include a physical position of the user, and the anticipated need may be to open a door. The network may send an inquiry which includes an audio request for confirmation of the anticipated need.

At 303, retrieve a schedule. A schedule may be compiled by habits the users of a home may have. For example, family members may not be in the home at certain times of the day. Also, the times and places when entertainment electronics is used by each user may be compiled. This may allow the home network to adapt the times in which it downloads content for each user (e.g. each family member).

In one embodiment, a woman may be driving home from work. This may be a time when she is scheduled to come home and the home network may retrieve this schedule and determine if she is nearing her home via a GPS on her smartphone. An App (application software) on her smart phone may be assisting in this process. As she comes within 50 yards of her home, the system may send an audio request for confirmation, “Open garage door, Miss?” If she responds “yes” to the request, the smartphone may relay the affirmative response to the home network and the home network may relay a command to the garage door device to open the door.

At 304, turn on a function of the RF enabled device according to the schedule. The RF enabled device may be a lighting driver/switch or general appliance which is part of a home mesh network. In one embodiment, the anticipated need is to save energy, and the criterion includes the schedule. In another embodiment, the schedule is dynamically provided by a power plant. For example, say at 2 pm PG&E (Pacific Gas & Electric) experience a drop in electric usage from 2 pm-3 pm every Wednesday for some reason and update a schedule on their website. The home network may periodically poll for updates to this schedule and when the home network determines this change, the schedule may be used to turn on the dishwasher and dryer to take advantage of the lower rates.

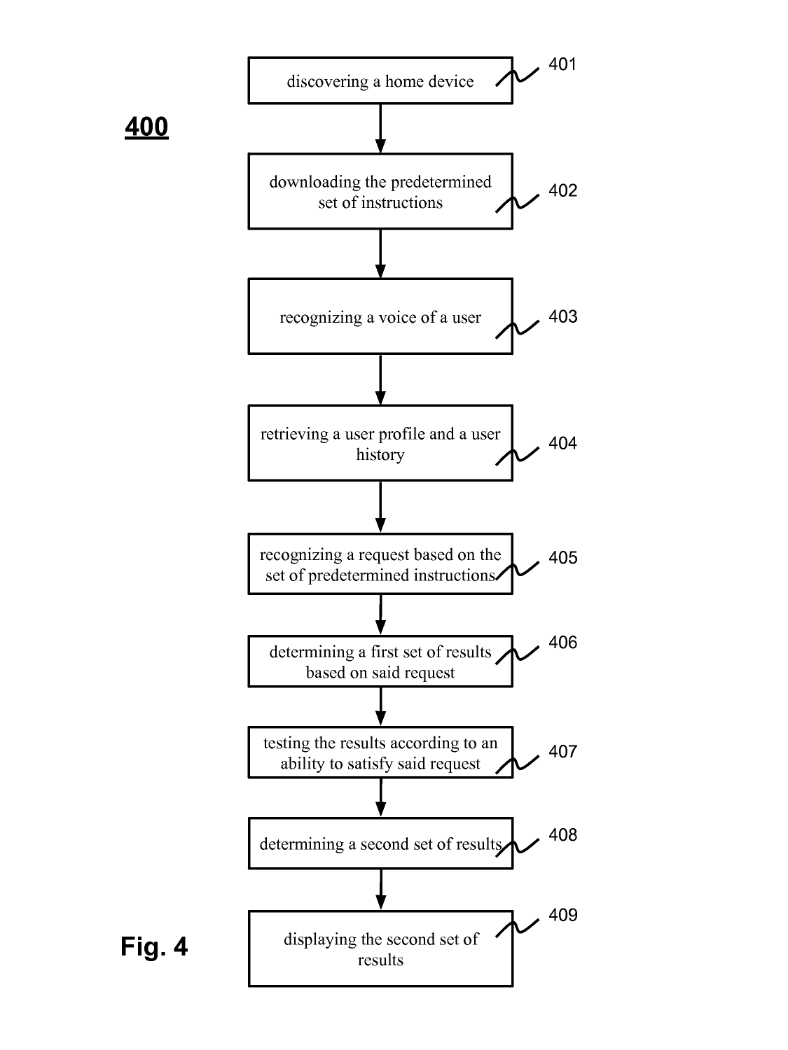

FIG. 4 illustrates a method 400 of providing a home network according to another embodiment of the invention. The method 400 includes discovering, downloading, recognizing a voice, retrieving, recognizing a request, determining a first set of results, testing, determining a second set of results, and displaying the results.

At 401, discover a home device. The home device may be a RF enabled device in a mesh network wherein new devices seek recognition from the home network upon power up.

At 402, download predetermined set of instructions from the internet in response to the discovery of the home device. The predetermined set of instructions may correspond to a home device such as a RF enabled lighting device, for example. The predetermined set of instructions may be a set of voice commands which correspond to a function of that particular device. For example, a RF enabled lighting device may simply have commands such as “on”, “off”, and “dim”.

At 403, recognize a voice of a user. The recognition may use software available on a computer within the home network. In other embodiments, the recognition software may be on a smartphone or available through the internet. The voice may be coupled through a microphone to a computer which may process the data.

At 404, retrieve a user profile and a user history in response to the recognizing of the voice. A user history may be compiled over time and may be particular to each user as described above. The profile may include interests and preferences such as hobbies, sports, temperature settings, and lighting settings. Preferences may also include whether a user wishes to be alerted to incoming calls visually when viewing a program or movie. The preference may be specific as well. For example, a user may wish only to be alerted to incoming call when watching non-movie content.

At 405, recognize a request based on the set of predetermined instructions. Each device on the network including a possible main computer (e.g. computer 101 of FIG. 1) may have a set of predetermined instructions. The recognition of the instruction may be accomplished on this computer. A limited vocabulary may assist in making the recognition of instruction simpler.

In other embodiments, the request may involve control of a home device and the user profile allows access to the home device. For example, a parent may have a workshop, and turning on the power equipment may only be permitted by authorized users reflected in their user profiles.

At 406, determine a set of results based on the request. The results may be a set of search results from a request for information. In other embodiments, the results may be a handshake from a remote RF device indicating a command has been received. For example, there may be a plurality of sprinklers which the user requested to turn on.

The above description illustrates various embodiments of the present invention along with examples of how aspects of the present invention may be implemented. The above examples and embodiments should not be deemed to be the only embodiments, and are presented to illustrate the flexibility and advantages of the present invention. Based on the above disclosure, other arrangements, embodiments, implementations and equivalents will be evident to those skilled in the art and may be employed without departing from the spirit and scope of the invention.

At 407, test the set of results according to an ability to satisfy the request. If the request was an internet search, the ability may include the download speed of a website corresponding to content. The test may include a measuring of the download speed. In other embodiments the testing may include sensing if a light has been turned on. In another embodiment the ability may include a resolution of a video which is part of a search result. If a user has a large screen display inferior video may not be desired. This desire may be part of the user's preferences, and the test of the set of the video quality may be in the context of the user profile. The test may be in the context of the user's history.

At 408, determining a second set of results based on the testing. If the request was an internet search and the set of results included content, the second set of results may be a subset which includes only content elements which could be downloaded within a predetermined period of time. The subset may include only videos which may be displayed in real time. In other embodiments, the lights in the home network which have been instructed to turn on, but are not “on” (i.e. have been tested at 407), may result in those possibly defective light modules to be turned off. Included in this second set of results may be an audio or visual message indicating certain lights are not responsive to the request and are subsequently turned off.

At 409, present the second set of results. This may be done on any number of displays or through audio outputs. These results may be sent as text message to a user.

What is claimed is:

1. A method of providing content to a user, said method comprising:
initiating a focused search for said content on the internet in response to satisfaction of a criterion rather than any deliberate action of said user, wherein said focused search corresponds to an interest of said user.

2. The method of claim 1 further comprising:
loading a result of said focused search for future viewing by said user.

3. The method of claim 1 further comprising:
evaluating content attributes according to a second criterion, said content attributes corresponding to a result of said focused search, wherein said second criterion includes consideration of a future viewing experience of said user in regard to said result.

4. The method of claim 3 wherein said content attributes includes a download speed from each website corresponding to said result.

5. The method of claim 3 wherein said content attributes includes updates to said content and said second criterion includes a schedule of content retrieval from a predetermined set of content providers.

6. The method of claim 5 wherein said predetermined set of content providers is established from a history of user experiences having said interest in common.

7. The method claim 3 wherein content attributes include an element of a set and said evaluating includes prioritizing said content which is more exclusive to said element, wherein said element corresponds to said interest.

8. The method of claim 7 wherein said element is a sport team belonging to an organization of sport teams, said sport team being said interest of said user.

9. A method of providing service to a user, said method comprising:
initiating an inquiry to provide said service in response to satisfaction of a criterion rather than any deliberate action of said user, wherein said inquiry corresponds to an anticipated need of said user.

10. The method of claim 9 further comprising:
retrieving a status of a remote wireless device, wherein said status corresponds to said criterion.

11. The method of claim 10 wherein said criterion includes a physical position of said user.

12. The method of claim 11 wherein said anticipated need is to open a door, and wherein said inquiry includes an audio request for confirmation of said anticipated need.

13. The method of claim 9 further comprising:
retrieving a schedule of excess energy availability from the internet; and
turning on a function of said remote wireless device according to said schedule,
wherein said anticipated need is to save energy, and wherein said criterion includes said schedule.

14. The method of claim 13 wherein said schedule is dynamically provided by a power plant.

15. A method comprising:
recognizing a voice of a user;
retrieving a user profile and a user history in response to said recognizing said voice;
recognizing a request based on a set of predetermined instructions; and
determining a first set of results based on said request, said user profile, said user history.

16. The method of claim 15 further comprising
testing said results according to an ability to satisfy said request; and
determining a second set of results based on said testing.

17. The method of claim 16 wherein said ability includes the download speed of a website corresponding to a content.

18. The method of claim 16 wherein said ability includes a visual resolution of a video of said content.

19. The method of claim 16 wherein said request involves control of a home device and said user profile allows access to said home device,
wherein said predetermined set of instructions correspond to said home device.

20. The method of claim 19 further comprising:
discovering said home device; and
downloading said predetermined set of instructions from the internet in response to said discovering.
